(19) United States
(12) Patent Application Publication
(10) Pub. No.: US 2020/0387839 A1
(43) Pub. Date: Dec. 10, 2020

(54) ESTIMATING PASSENGER INCOME LEVEL ON A RIDESHARING PLATFORM

(71) Applicant: DiDi Research America, LLC, Mountain View, CA (US)

(72) Inventors: Zetian NI, Sunnyvale, CA (US); Xin CHEN, Sunnyvale, CA (US); Dong LI, Santa Clara, CA (US); Jing CHEN, Palo Alto, CA (US)

(21) Appl. No.: 16/435,106

(22) Filed: Jun. 7, 2019

(51) Int. Cl. G06Q 10/02; G06Q 50/30; G06Q 50/16; G06Q 30/02

(52) U.S. Cl. CPC G06Q 10/02; G06Q 30/0201; G06Q 50/16; G06Q 50/30

(57) ABSTRACT

After determining a residence address of a passenger, a geohash of the residence address of the passenger can be determined. An income level of the passenger can be determined based on (i) a median property price of an area, in a service area, with a geohash comprised in the geohash of the residence address of the passenger, and (ii) the median property price of the service area.

### TECHNICAL FIELD

The disclosure relates generally to ridesharing platforms.

### BACKGROUND

Under traditional approaches, ridesharing platforms may be able to connect passengers and drivers on relatively short notice. However, traditional ridesharing platforms suffer from a variety of safety and security risks for both passengers and drivers.

### SUMMARY

One aspect of the present disclosure is directed to a system for ridesharing. In some embodiments, the system comprises: one or more processors; and a memory storing instructions that, when executed by the one or more processors, cause the system to perform: receiving a trip order from a passenger. The instructions, when executed by the one or more processors, can cause the system to perform: determining a residence address of the passenger. The instructions, when executed by the one or more processors, can cause the system to perform: determining a geohash of the residence address of the passenger. The instructions, when executed by the one or more processors, can cause the system to perform: determining an income level of the passenger based on (i) a median property price of a first area of a plurality of areas in a service area, and/or (ii) the median property price of the service area. The geohash of the residence address of the passenger can comprise a geohash of the first area of the plurality of areas in the service area. The instructions, when executed by the one or more processors, can cause the system to perform: determine a risk for the trip order based on the income level of the passenger. The instructions, when executed by the one or more processors, can cause the system to perform: determining a decision for the trip order based on the risk of the trip order.

In some embodiments, the decision for the trip order comprises an acceptance of the trip order and a decline of the trip order.

Another aspect of the present disclosure is directed to a system for income determination. In some embodiments, the system comprises: one or more processors; and/or a memory storing instructions that, when executed by the one or more processors, cause the system to perform: determining a residence address of a passenger. The instructions, when executed by the one or more processors, can cause the system to perform: determining a geohash of the residence address of the passenger. The instructions, when executed by the one or more processors, can cause the system to perform: determining an income level of the passenger based on a ratio of (i) a median property price of a first area of a plurality of areas in a service area, and/or (ii) the median property price of the service area. The geohash of the residence address of the passenger comprises a geohash of the first area of the plurality of areas in the service area. The instructions, when executed by the one or more processors, can cause the system to perform: receiving a new trip order from the passenger. The instructions, when executed by the one or more processors, can cause the system to perform: determining a decision for the new trip order based on the income level of the passenger.

In some embodiments, none of the plurality of areas in the service area overlap with one another, and different areas of the plurality of areas in the service area have different geohashes.

In some embodiments, determining the residence address of the passenger comprises determining the residence address of the passenger based on a location of the passenger during registration with the system. The location of the passenger can comprise a longitude and a latitude. The location of the passenger during registration with the system can correspond to a residence address in the service area.

In some embodiments, determining the residence address of the passenger comprises: determining geohashes of a start location and a destination location of each of a plurality of recent trip orders of the passenger; determining a number of the geohashes of the start locations and the destination locations having an identical geohash is at least an identical geohash threshold, wherein the identical geohash is a geohash of a residence address in the service area; and/or determining the identical geohash as the geohash of the residence address of the passenger.

In some embodiments, determining the residence address of the passenger comprises: determining geohashes of a start location and a destination location of each of a plurality of recent trip orders of the passenger; determining a number of the geohashes of the start locations and the destination locations having an identical geohash is below an identical geohash threshold; and/or determining a geohash of a start location or a destination location of a most recent trip order of the plurality of recent trip orders of the passenger as the geohash of the residence address of the passenger. The start location or the destination location of the most recent trip order determined as the residence address of the passenger can be a residence address in the service area.

In some embodiments, the geohash of the residence address of the passenger has a first precision, and the geohash of the first area of the plurality of areas in the service area has the first precision. The geohash of the residence address of the passenger can have a first precision, the geohash of the first area of the plurality of areas in the service area can have a second precision, and/or wherein the first precision has a higher precision than the second precision.

In some embodiments determining the income level of the passenger comprises: identifying the first area of the plurality of areas in the service area, the geohash of the first area being the geohash of the residence address of the passenger; obtaining the median property price of the first area of the plurality of areas in the service area; obtaining the median property price of the service area; and/or determining an income score of the passenger comprising a ratio of the median property price of the first area and the median property price of the service area. The income score of the passenger can indicate the income level of the passenger.

In some embodiments, determining the income level of the passenger comprises: obtaining a median property price of each of the plurality of areas in the service area that is available; obtaining the median property price of the service area; determining a ratio of the median property price of each of the plurality of areas in the service area and the median property price of the service area; identifying the first area of the plurality of areas in the service area; and/or determining an income score of the passenger comprising the ratio of the median property price of the first area and the median property price of the service area. The geohash of the residence address of the passenger can comprise the geohash of the first area. The income score of the passenger can indicate the income level of the passenger. In some embodiments, the income score of the passenger, ranked relative to income scores of other passengers of a ridesharing service or platform, indicates the income level of the passenger. In some embodiments, the instructions, when executed by the one or more processors, cause the system to perform: determining the median property price of each of the plurality of areas on the service area that is available periodically; and/or determining rankings of passengers of the system based on income levels of the passengers periodically. In some embodiments, determining the income score of the passenger can comprise updating the income score of the passenger from 0.5 to the ratio of the median property price of the first area and the median property price of the service area. In some embodiments, the income score of the passenger, ranked relative to ratios of (i) median property prices of areas of the plurality of areas in the service area other than the first service area and (ii) the median property price of the service areas, can indicate the income level of the passenger.

In some embodiments, determining the income level of the passenger comprises: determining median property prices of areas of the plurality of areas in the service area, wherein a median property price of a second area of the plurality of areas comprised in the first area is unavailable, wherein the geohash of the second area and the geohash of the residence property of the passenger are identical and have a precision higher than the geohash of the first area; obtaining the median property price of the service area; determining ratios of the median property prices of the areas of the plurality of areas in the service area and the median property price of the service area; identifying the geohash of the second area and the geohash of the residence address of the passenger are identical and the median property price of the second area is unavailable; identifying the first area of the plurality of areas in the service area as having the geohash of the first area comprised in the geohash of the residence address of the passenger; and/or determining an income score of the passenger comprising the ratio of the median property price of the first area and the median property price of the service area, wherein the income score of the passenger indicates the income level of the passenger.

Another aspect of the present disclosure is directed to a method for income determination. In some embodiments, the method comprises: determining a residence address of a passenger. The method can further comprise: determining a geohash of the residence address of the passenger. The method can further comprise: determining an income level of the passenger based on (i) a median property price of a first area of a plurality of areas in a service area, and/or (ii) the median property price of the service area. The geohash of the residence address of the passenger can comprise a geohash of the first area of the plurality of areas in the service area. The method can further comprise: receiving a new trip order from the passenger. The method can further comprise: determining a decision for the new trip order based on the income level of the passenger.

In some embodiments, none of the plurality of areas in the service area overlap with one another, and/or different areas of the plurality of areas in the service area have different geohashes.

In some embodiments, determining the residence address of the passenger comprises determining the residence address of the passenger based on a location of the passenger during registration with a ridesharing service or platform. The location of the passenger can comprise a longitude and a latitude. The location of the passenger during registration can correspond to a residence address in the service area.

In some embodiments, determining the residence address of the passenger comprises: determining geohashes of a start location and a destination location of each of a plurality of recent trip orders of the passenger; determining a number of the geohashes of the start locations and the destination locations having an identical geohash is at least an identical geohash threshold, wherein the identical geohash is a geohash of a residence address in the service area; and/or determining the identical geohash as the geohash of the residence address of the passenger.

In some embodiments, determining the residence address of the passenger comprises: determining geohashes of a start location and a destination location of each of a plurality of recent trip orders of the passenger; determining a number of the geohashes of the start locations and the destination locations having an identical geohash is below an identical geohash threshold; and/or determining a geohash of a start location or a destination location of a most recent trip order of the plurality of recent trip orders of the passenger as the geohash of the residence address of the passenger. The start location or the destination location of the most recent trip order determined as the residence address of the passenger can be a residence address in the service area.

In some embodiments, the geohash of the residence address of the passenger has a first precision, and the geohash of the first area of the plurality of areas in the service area has the first precision. The geohash of the residence address of the passenger can have a first precision, the geohash of the first area of the plurality of areas in the service area can have a second precision, and the first precision can have a higher precision than the second precision.

In some embodiments, determining the income level of the passenger comprises: identifying the first area of the plurality of areas in the service area, the geohash of the first area being the geohash of the residence address of the passenger; obtaining the median property price of the first area of the plurality of areas in the service area; obtaining the median property price of the service area; and/or determining an income score of the passenger comprising a ratio of the median property price of the first area and the median property price of the service area. The income score of the passenger can indicate the income level of the passenger.

In some embodiments, determining the income level of the passenger comprises: obtaining a median property price of each of the plurality of areas in the service area that is available; obtaining the median property price of the service area; determining a ratio of the median property price of each of the plurality of areas in the service area and the median property price of the service area; identifying the first area of the plurality of areas in the service area; and/or determining an income score of the passenger comprising the ratio of the median property price of the first area and the median property price of the service area. The geohash of the residence address of the passenger can comprise the geohash of the first area. The income score of the passenger can indicate the income level of the passenger. In some embodiments, the income score of the passenger, ranked relative to income scores of other passengers of a ridesharing service or platform, indicates the income level of the passenger. In some embodiments, the income score of the passenger, ranked relative to ratios of (i) median property prices of areas of the plurality of areas in the service area other than the first service area and (ii) the median property price of the service areas, indicates the income level of the passenger. In some embodiments, the method further comprises: determining the median property price of each of the plurality of areas on the service area that is available periodically; and/or determining rankings of passengers of a ridesharing service or platform based on income levels of the passengers periodically. In some embodiments, determining the income score of the passenger comprises updating the income score of the passenger from 0.5 to the ratio of the median property price of the first area and the median property price of the service area.

In some embodiments, determining the income level of the passenger comprises: determining median property prices of areas of the plurality of areas in the service area, wherein a median property price of a second area of the plurality of areas comprised in the first area is unavailable, wherein the geohash of the second area and the geohash of the residence property of the passenger are identical and have a precision higher than the geohash of the first area; obtaining the median property price of the service area; determining ratios of the median property prices of the areas of the plurality of areas in the service area and the median property price of the service area; identifying the geohash of the second area and the geohash of the residence address of the passenger are identical and the median property price of the second area is unavailable; identifying the first area of the plurality of areas in the service area as having the geohash of the first area comprised in the geohash of the residence address of the passenger; and/or determining an income score of the passenger comprising the ratio of the median property price of the first area and the median property price of the service area, wherein the income score of the passenger indicates the income level of the passenger.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an example environment for a ridesharing platform system, in accordance with various embodiments of the disclosure.

FIG. 2 illustrates an example environment for a ridesharing platform system, in accordance with various embodiments of the disclosure.

FIG. 3 illustrates an example income level heatmap, in accordance with various embodiments of the disclosure.

FIG. 4 is an example workflow for determining passenger income levels, in accordance with various embodiments of the disclosure.

FIG. 5 is an example workflow for determining passenger residence addresses, in accordance with various embodiments of the disclosure.

FIG. 6 is a flowchart of an example method for determining passenger income levels, in accordance with various embodiments of the disclosure.

FIG. 7 is a block diagram of an example computer system in which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may improve the safety and security of a ridesharing service. More specifically, for example, the approaches disclosed herein enable and/or improve driver safety in a ridesharing service, for example, by estimating or determining passenger income and estimating the risk of a trip order for the driver using the passenger income. An exponential relationship exists between the income level and the rate of incidents, such as a crime rate, in a city (e.g., repeat criminal victimization). Incidents can include physical incidents (e.g., property losses and physical harms to drivers and passengers). A strong correlation exists between the income level and the probability of incidents (e.g., committing crimes) on a ridesharing service or platform. An exponential correlation exists between the passenger's income level and the passenger's incident ratio (e.g., crime ratio). The income level of a passenger on a ridesharing service or platform can be determined based on the passenger's residence address. For example, a geohash of the residence address of the passenger can be determined. An income level of the passenger can be determined based on (i) a median property price of an area, in a service area, with a geohash comprised in the geohash of the residence address of the passenger, and (ii) the median property price of the service area. A decision on a trip order by the passenger can be determined based on the likelihood of an incident occurring with the passenger as the perpetrator and the driver being the victim, which in turn can be determined based on the income level of the passenger.

### Passenger, Driver, and Ridesharing Platform System Interactions

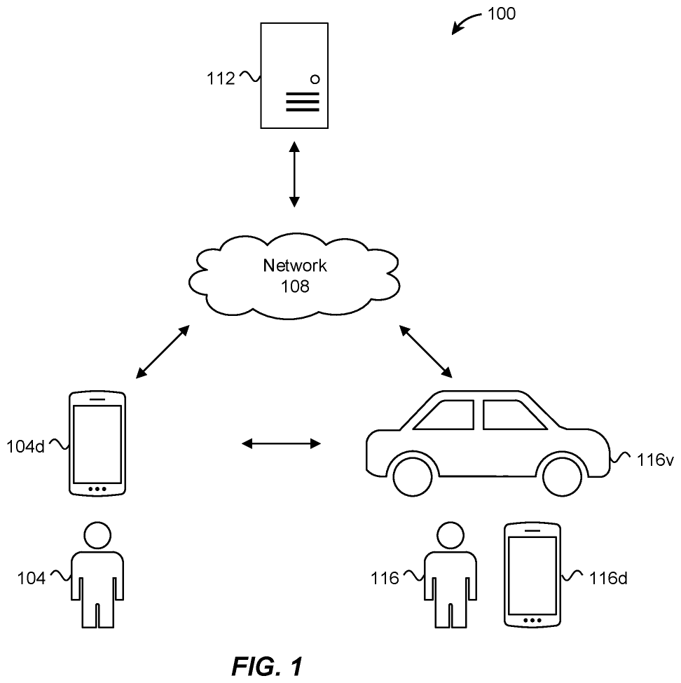

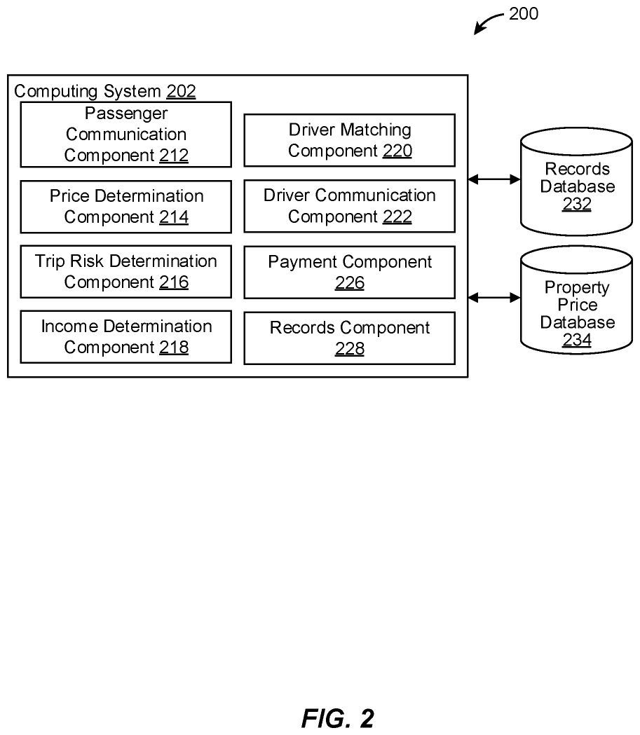

FIG. 1 illustrates an example environment for a ridesharing platform system. In the environment 100 illustrates in FIG. 1, a passenger 104 uses a passenger device 104d (e.g., a smartphone, a tablet, or a computer) to make a trip request, via a communication network 108 (e.g., the Internet) to a ridesharing platform system 112 (such as the computing system 200 described with reference to FIG. 2). The ridesharing platform system 112 can in turn assign a driver 116 and the driver's vehicle 116 (e.g., a car, a SUV, and a truck) to fulfil the trip request. The driver 116 can receive and accept or decline the trip request using a driver device 116d (e.g., a smartphone, a tablet, or a computer). The driver device 116d can be a standalone device or part of the driver's vehicle 116.

During an onboarding process, the passenger 104 and the driver 116 can provide personal information to the ridesharing platform system 112. Stringent background checks can increase driver safety and passenger safety. The passenger 104 can provide the ridesharing platform system 112 with a pickup or starting location and a drop off or destination location of a trip and receive pricing information (e.g., the estimated cost of the trip) and timing information (e.g. the estimated duration of the trip). If the pricing information and timing information are acceptable to the passenger 104, the passenger 104 can make a trip request or place an order (e.g., by clicking an order button) to the ridesharing platform system 112. After receiving the trip request from the passenger 104, the ridesharing platform system 112 can decide whether to accept the trip request and assign or match the driver 116 to the passenger for the particular trip request. Declining or rejecting a trip request of a passenger determined to be likely an offender in an incident can increase driver safety. The driver 116 can proceed to and arrive at the pickup location, where the passenger 104 can enter the driver's vehicle 116v and be transported, by the driver 116 using the vehicle 116v, to the drop off location of the trip request or order. The passenger 104 can pay (e.g., with cash or via the ridesharing platform system 112) the driver 116 after arrival at the drop off location.

Using the passenger device 104d, the passenger 104 can interact with the ridesharing platform system 112 and request ridesharing services. For example, the passenger 140, using the passenger device 104d, can make a trip request to the ridesharing platform system 112. A trip request can include rider identification information, the number of passengers for the trip, a requested type of the provider (e.g., a vehicle type or service option identifier), the pickup location (e.g., a user-specified location, or a current location of the passenger device 104d as determined using, for example, a global positioning system (GPS) receiver), and/or the destination for the trip.

The passenger device 104d can interact with the ridesharing platform system 112 through a client application configured to interact with the ridesharing platform system 112. The client application can present information, using a user interface, received from the ridesharing platform system 112 and transmit information to the ridesharing platform system 112. The information presented on the user interface can include driver-related information, such as driver identity, driver vehicle information, driver vehicle location, and driver estimated arrival. The information presented on the user interface can include the drop off location, a route from the pickup location to the drop off location, an estimated trip duration, an estimated trip cost, and current traffic condition. The passenger device 104d can include a location sensor, such as a global positioning system (GPS) receiver, that can determine the current location of the passenger device 104d. The user interface presented by the client application can include the current location of the passenger device 104. The information transmitted can include a trip request, a pickup location, and a drop off location.

The ridesharing platform system 112 can allow the passenger 104 to specify parameters for the trip specified in the trip request, such as a vehicle type, a pick-up location, a trip destination, a target trip price, and/or a departure timeframe for the trip. The ridesharing platform system 112 can determine whether to accept or reject the trip request and, if so, assign or attempt to assign the driver 116 with the driver vehicle 116v and the driver device 116d to the passenger 104 and the passenger's trip request. For example, the ridesharing platform system 112 can receive a trip request from the passenger device 104d, select a driver from a pool of available drivers to provide the trip, and transmit an assignment request to the selected driver's device 116d.

The driver 116 can interact with, via the driver device 116d, the ridesharing platform system 112 to receive an assignment request to fulfill the trip request. The driver can decide to start receiving assignment requests by going online (e.g., launching a driver application and/or providing input on the driver application to indicate that the driver is receiving assignments), and stop receiving assignment requests by going offline. The driver 116 can receive, from the ridesharing platform system 112, an assignment request to fulfill a trip request made by the passenger using the passenger device 104d to the ridesharing platform system 112. The driver 116 can, using the driver device 116d, accepting or reject the assignment request. By accepting the assignment request, the driver 116 and the driver's vehicle 116v is assigned to the particular trip of the passenger 104, and is provided the passenger's pickup location and trip destination.

The driver device 116d can interact with the ridesharing platform system 112 through a client application configured to interact with the ridesharing platform system 112. The client application can present information, using a user interface, received from the ridesharing platform system 112 (e.g., an assignment request, a pickup location, a drop off location, a route from the pickup location to the drop off location, an estimated trip duration, current traffic condition, and passenger-related information, such as passenger name and gender) and transmit information to the ridesharing platform system 112 (e.g., an acceptance of an assignment request). The driver device 116d can include a location sensor, such as a global positioning system (GPS) receiver, that can determine the current location of the driver device 116d. The user interface presented by the client application can include the current location of the driver device 116 and a route from the current location of the driver device 116 to the pickup location. After accepting the assignment, the driver 116, using the driver's vehicle 116v, can proceed to the pickup location of the trip request to pick up the passenger 104.

The passenger device 104d and the driver device 116d can communicate with the ridesharing platform system 112 via the network 108 The network 108 can include one or more local area and wide area networks employing wired and/or wireless communication technologies (e.g., 3G, 4G, and 5G), one or more communication protocols (e.g., transmission control protocol/Internet protocol (TCP/IP) and hypertext transport protocol (HTTP)), and one or more formats (e.g., hypertext markup language (HTML) and extensible markup language (XML).

### Ridesharing Platform System

FIG. 2 illustrates an example environment 200 for a ridesharing platform system, in accordance with various embodiments. The example environment 200 may include a ridesharing computing system 202. The computing system 202 may include one or more processors and memory (e.g., permanent memory, temporary memory). The processor(s) may be configured to perform various operations by interpreting machine-readable instructions stored in the memory. The computing system 202 may include other computing resources. The computing system 202 may have access (e.g., via one or more connections, via one or more networks) to other computing resources.

The computing system 202 may include a passenger communication component 212, a price determination component 214, a trip risk determination component 216, an income determination component 218, a driver matching component 220, a driver communication component 224, a payment component 226, and a trip records component 228. The computing system 202 may include other components. While the computing system 202 is shown in FIG. 2 as a single entity, this is merely for ease of reference and is not meant to be limiting. One or more components or one or more functionalities of the computing system 202 described herein may be implemented in software. One or more components or one or more functionalities of the computing system 202 described herein may be implemented in hardware. One or more components or one or more functionalities of the computing system 202 described herein may be implemented in a single computing device or multiple computing devices. In some embodiments, one or more components or one or more functionalities of the computing system 202 described herein may be implemented in one or more networks (e.g., enterprise networks), one or more endpoints, one or more servers, or one or more clouds.

A passenger, such as the passenger 104 described with reference to FIG. 1 (or a passenger's device, such as the passenger device 104 described with reference to FIG. 1) can communicate with the ridesharing computing system 202 via the passenger communication component 212. For example, during the trip request process, the passenger can provide personal information to the ridesharing computing system 202 via the passenger communication component 212. For example, the passenger can provide the ridesharing computing system 202, via the passenger communication component 212, with a pickup location and a drop off location of a trip. For example, the passenger communication component 212 can provide the passenger with pricing information of the trip (e.g., the estimated cost of the trip) and timing information of the trip (e.g. the estimated duration of the trip). If the pricing information and timing information are acceptable to the passenger, the passenger can make a trip request or place an order (e.g., by clicking an order button) to the ridesharing computing system 202, via the passenger communication component 212. After receiving the trip request from the passenger, the ridesharing computing system 202 can determine whether to accept or decline the trip request or order based on a risk of the trip determined by the risk determination component 216. The risk determination component 216 can determine the risk of the trip using the income level of the passenger determined by the income determination component 218. If the risk is acceptable (e.g., below a threshold level), the ridesharing computing system 202 can assign or match the driver to the passenger for the particular trip request using the driver matching component 220. The ridesharing computing system 202, using the driver communication component 224, can provide the assigned driver with an assignment of the trip request. The ridesharing computing system 202, using the driver communication component 224, can receive the driver's acceptance of the assignment of the trip request. The driver communication component 224 can provide the driver with information relating to the progress of the trip, such as the driver's distances from the pickup location and drop off location and a route from the pickup location to the drop off location. The ridesharing computing system 202, using the payment component 226, can receive the passenger's payment for the trip. The records component 228 can store information related to the trip (e.g., the driver information) in the records database 232. The records database 232 can also store the passenger information and the driver information (e.g., received during the registration process, such as the passenger's name, or trip request process).

### Income Estimation

Referring to FIG. 2, to determine or estimate the income level of a passenger in a service area (e.g., a part of a city, a city, or multiple cities) of a ridesharing service or platform, the income determination component 218 can obtain market prices or values of residential properties in the service area. The income determination component 218 may acquire, analyze, determine, examine, identify, load, locate, obtain, open, receive, retrieve, and/or review the residence property market value. The income determination component 218 can access such price information from one or more locations. For example, the income determination component 218 can access the price information from a storage location, such as an electronic storage of the computing system 202 in FIG. 2 (e.g., the gender frequencies database 234 in FIG. 2), an electronic storage of a device accessible via a network, another computing device/system (e.g., desktop, laptop, smartphone, tablet, mobile device), or other locations. The coverage of residential property values in major cities is very high (e.g., 85%, 90%, 95%, or 99%).

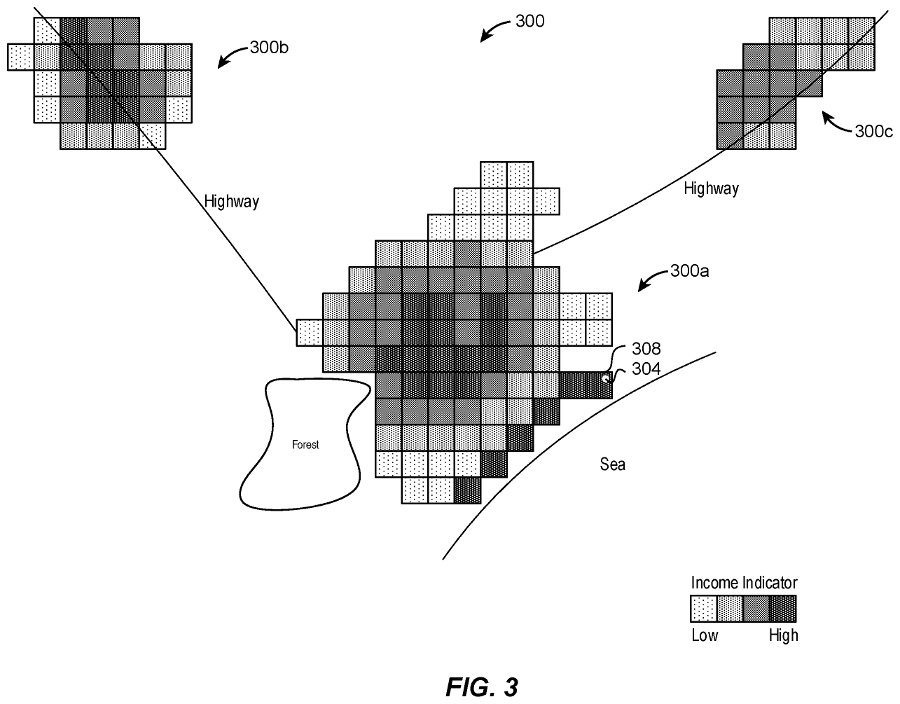

The income determination component 218 can determine the passenger's residence address (e.g., the residence address 304 in FIG. 3). Many (e.g., most) passengers may register accounts on a ridesharing service or platform at or near their homes. Starting locations or destination locations of users' trips often are the passenger's homes. For a passenger with a registration location that corresponds to a residence address, the longitude and latitude of the registration location can be used as the passenger's residence address. For a passenger without a registration location or a registration location not corresponding to any residence properties, the income determination component 218 can use, or implement, a function (such as a Find-Home Function) to determine the passenger's residence address.

The income determination component 218 can calculate a passenger's income level using the passenger's residence property price or value. The income determination component 218 can calculate median residence property prices of areas within a service area (e.g., a city). For example, the income determination component 218 can calculate median residence property prices of areas, within the service area, with geohashes of different precisions, such as 6-character geohashes, 7-character geohashes, and 8-character geohashes. FIG. 3 illustrates an example income level heatmap of a service area. The service area 300 illustrated in FIG. 3 includes three disjoint areas 300a-300c. In some embodiments, a service area includes multiple cities. In some embodiments, a service area includes one city. In some embodiments, a service area includes a part of the city. An area with an individual block in FIG. 3 has a geohash of a particular precision (e.g., geohashes with a precision of eight characters). An area that includes 2×2 blocks in the service area 300 can have a geohash of a lower precision (e.g., geohashes with a precision of seven characters) than an area with an individual block. An area that includes 4×4 blocks in the service area 300 can have geohash of a lower precision (e.g., geohashes with a precision of six characters) than an area of with an individual block and an area with 2×2 blocks. All of the blocks in FIG. 3 can correspond to residential areas, or some of the blocks in FIG. 3 (e.g., block 308) can correspond to residential areas.

Referring to FIG. 2, the income determination component 218 can calculate the median residence property price of the service area (e.g., the service area 300 in FIG. 3). The income determination component 218 can calculate ratios of median residence property prices of areas within the service area divided by the median residence property price of the service area as income scores. For example, income determination component 218 can calculate a ratio of the median property price of an area 308 that includes the residence address 304 of the passenger and the median property price of the service area 300 illustrated in FIG. 3. Referring to FIG. 2, the income determination component 218 can match the passenger's residence address to an area that includes the passenger's residence address and use the income score of the area that includes the passenger's residence address as the passenger's income level. For example, the income determination component 218 can use the residence property price ranking (e.g., percentile ranking) of the area that includes the passenger's residence address, relative to the residence property prices of other areas in the service area, as the passenger's income level. The passenger's income level can be a ranking of the income score of the area that includes the passenger's residence property relative other the income scores of other areas in the service area. As another example, the income determination component 218 can determine a ranking of the passenger's residence property price relative to the residence property prices of other passengers with residence addresses in the service area and use the ranking as the passenger's income level. The passenger's income level can be a ranking of the income score of the area that includes the passenger's residence property relative to the income scores of other passengers with residence addresses in the service area.

For a passenger without a registration location or with a registration location not corresponding to any residence properties (or residential areas), the income determination component 218 can use, or implement, a function (such as a Find-Home Function) to determine the passenger's residence address. The Find-Home Function can obtain (e.g., from the records database 232) the geohashes of the starting locations and destination locations, of the passenger's latest orders (e.g., latest 3, 5, or 10 orders), that correspond to residential addresses. If, for example, three of the starting locations and destination locations of the latest orders have an identical geohash that corresponds to a residential area (e.g., the area 308 in FIG. 3), then the Find-Home Function can return that identical geohash as the passenger's residence address. Otherwise, the Find-Home Function can return the geohash of the starting location or the destination location of the passenger's most recent order that corresponds to a residential area. Accordingly, a residence address (in terms of a geohash of a residential area) can be determined for a passenger without a registration location or with a registration location that does not correspond to any residence properties (or residential areas) and with few orders on the ridesharing service or platform.

The income determination component 218 may be unable to determine the income level the passenger, for example, because the geohash of the residence address of the passenger has a precision of eight characters and the area with the geohash of the passenger's residence address is not a residential area. In some embodiments, the income determination component 218 can extend the matching criteria for geohashes from a precision of eight character to a precision of seven character. If the area with the geohash of the passenger's residence address having a precision of seven characters is not a residential area is not a residential area, the income determination component 218 can extend the matching criteria for geohashes from a precision of seven character to a precision of six character. By extending matching range, the income determination component 218 can determine most accurate income level for the passenger while ensuring the coverage of income level among passengers.

The income determination component 218 can define initial income levels of passengers based on the passengers' residence properties. For example, the income determination component 218 can calculate the passengers' initial income levels directly from income scores of the areas of the passenger's residence properties because income scores of residence properties are independent of users. As another example, the income determination component 218 can determine passengers' income levels based on relative passenger income levels. In one illustrative example, for the first 1000 passengers in a service area (e.g., a city) of a ridesharing service or platform, the income determination component 218 can use a default value (e.g., 0.5 as income percentile) as passengers' income levels and start ranking the passengers' income scores to determine passengers' income levels after more than 1000 passengers join or use the ridesharing service or platform.

In some embodiments, the income determination component 218 can update or iterate passengers' income levels and residence property values periodically (e.g., daily, weekly, or monthly). For example, the income determination component 218 can iterate residence property values (e.g., median residence property values of areas in the service area and a median property value of the service area) and passenger income levels to ensure time-effectiveness and overall income level standard. The income determination component 218 can perform the iterations offline daily.

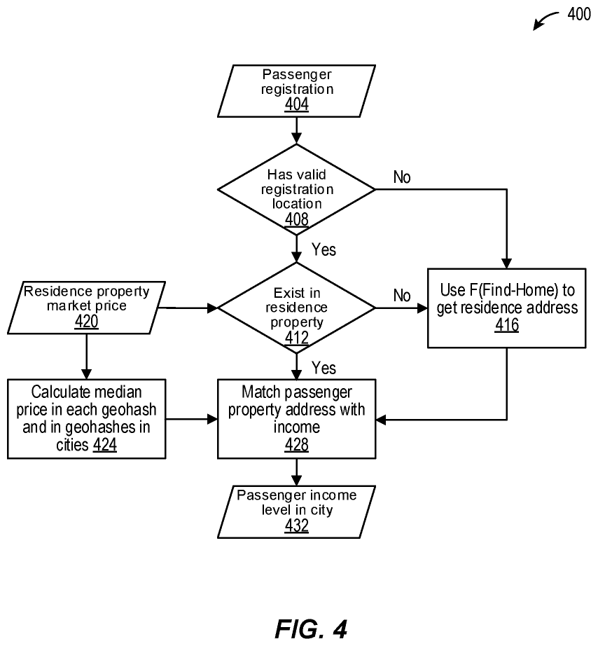

FIG. 4 is an example workflow for determining passenger income levels, in accordance with various embodiments of the disclosure. The income determination component 218 can implement the example workflow 400 in FIG. 4. At decision block 408, if a passenger's registration 404 includes a valid registration location (e.g., the GPS location of the passenger's device 104d in FIG. 1) that corresponds to a residence address 412, the longitude and latitude of the registration location can be used as the passenger's residence address. For a passenger without a registration location at decision block 408 or a registration location not corresponding to any residence properties at decision block 412, a Find-Home Function can be used to determine the passenger's residence address at block 416.

A passenger's income level 432 in the service area can be determined using the passenger's residence property price or value. Using residence property prices 420 of areas within a service area (e.g., a city), a median property prices can be calculated at block 424. Ratios of median residence property prices of areas within the service area divided by the median residence property price of the service area as income scores can be calculated. The passenger's residence address can be matched at block 428 to an area that includes the passenger's residence address and use the income score of the area that includes the passenger's residence address as the passenger's income level 432.

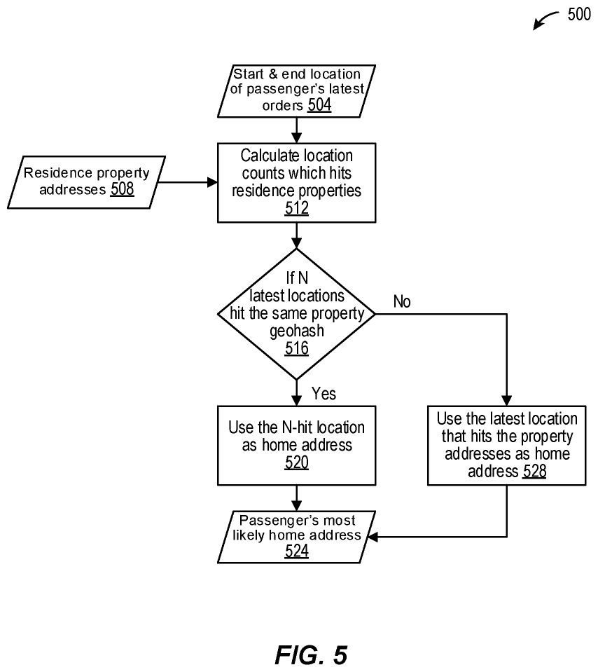

FIG. 5 is an example workflow for determining passenger residence addresses, in accordance with various embodiments of the disclosure. The income determination component 218 can implement the example workflow 500 in FIG. 5. For a passenger without a registration location or with a registration location not corresponding to any residence properties (or residential areas), the income determination component 218 can use, or implement, a Find-Home Function to determine the passenger's residence address. From the starting locations and destination locations of the passenger's latest orders 504 (e.g., latest 3, 5, or 10 orders) and residence property addresses 508 in the service area, the number of the starting locations and destination locations that are residence properties can be determined at block 512. If the number of starting locations and destination locations with an identical geohash is equal to or greater than a threshold (e.g., three) at decision block 516, then the identical geohash can be used as the passenger's residence address 524 at block 520. If the number of starting locations and destination locations with an identical geohash is below a threshold at decision block 516, then the geohash of the starting location or the destination location of the passenger's most recent order that corresponds to a residential area can be used as the passenger's residence address 524 at block 528.

### Income Estimation Method

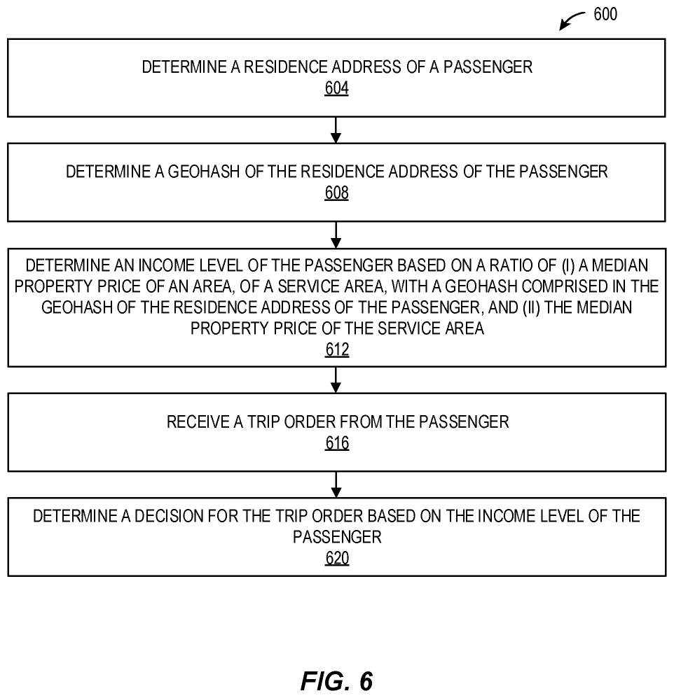

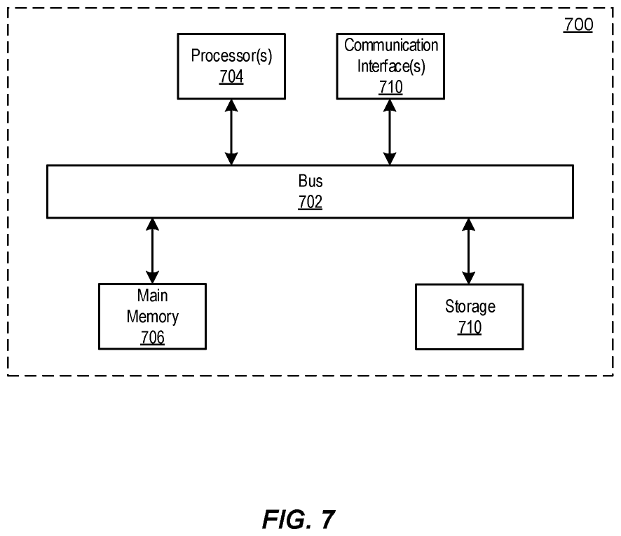

FIG. 6 illustrates a flowchart of an example method 600, according to various embodiments of the present disclosure. The method 600 may be implemented in various environments including, for example, the environment 200 of FIG. 2 and by computer systems, such as the computer system 202 of FIG. 2 or the computer system 700 of FIG. 7. The operations of the method 600 presented below are intended to be illustrative. Depending on the implementation, the method 600 may include additional, fewer, or alternative steps performed in various orders or in parallel. The method 600 may be implemented in various computing systems or devices including one or more processors.

With respect to the method 600, at block 604, a computer system, such as the computer system 202 of FIG. 2 or the computer system 700 of FIG. 7, can determine a residence address of a passenger. In some embodiments, to determine the residence address of the passenger, the computer system can determine the residence address of the passenger based on a location of the passenger during registration with the system. The location of the passenger can comprise a longitude and a latitude. The location of the passenger during registration can correspond to a residence address in the service area.

In some embodiments, to determine the residence address of the passenger, the computer system can determine geohashes of a start location and a destination location of each of a plurality of recent trip orders of the passenger (e.g., 3, 4, 5, 10 or more). The computer system can determine a number of the geohashes of the start locations and the destination locations having an identical geohash is at least an identical geohash threshold (e.g., 2, 3, 4, 5, or more). For example, out of three recent trips with three start locations and three destination locations, the number of the geohashes of the start locations and the destination locations having an identical geohash can be equal to or greater than the identical geohash threshold of three. For example, out of five recent trips, the number of the geohashes of the start locations and the destination locations having an identical geohash can be equal to or greater than the identical geohash threshold of three. The identical geohash can be a geohash of a residence address in the service area. The computer system can determine the identical geohash as the geohash of the residence address of the passenger. In some embodiments, the computer system can determine one or more of the geohashes of the start locations and the destination locations are geohashes of one or more residence addresses. The computer system can determine a number of the geohashes of the one or more residence addresses being an identical geohash is at least an identical geohash threshold.

In some embodiments, to determine the residence address of the passenger, the computer system can determine geohashes of a start location and a destination location of each of a plurality of recent trip orders of the passenger. The computer system can determine a number of the geohashes of the start locations and the destination locations having an identical geohash is below an identical geohash threshold. The computer system can determine a geohash of a start location or a destination location of a most recent trip order of the plurality of recent trip orders of the passenger as the geohash of the residence address of the passenger. The start location or the destination location of the most recent trip order determined as the residence address of the passenger can be a residence address in the service area. In some embodiments, the computer system can select a most recent order of the plurality of recent orders with a start location and/or a destination location being a residence address in the service area. The computer system can determine the start location or the destination location as the geohash of the residence address of the passenger.

With respect to the method 600, at block 608, the computer system can determine a geohash of the residence address of the passenger. A geohash is a way of expressing any location on earth using a short alphanumeric string, with greater precision obtained with longer strings with more characters. Geohashing is a hierarchical spatial data structure which subdivides space on earth into buckets of grid shape. A geohash can represent a square or rectangular area.

With respect to the method 600, at block 612, the computer system can determine an income level of the passenger based on (i) a median property price of a first area of a plurality of areas in a service area and (ii) the median property price of the service area. The geohash of the residence address of the passenger can comprise a geohash of the first area of the plurality of areas in the service area. The geohash of the residence address of the passenger can have a higher precision than the geohash of the first area. For example, the geohash of the residence address of the passenger can have a precision of eight characters, and the geohash of the first area in the service area can have a precision of seven or six (or fewer) characters. In some embodiments, none of the plurality of areas in the service area overlap with one another, and/or different areas of the plurality of areas in the service area have different geohashes.

In some embodiments, the geohash of the residence address of the passenger has a first precision (e.g., a precision of eight characters), and the geohash of the first area of the plurality of areas in the service area has the first precision (e.g., a precision of eight characters). The geohash of the residence address of the passenger can have a first precision (e.g., a precision of eight characters), the geohash of the first area of the plurality of areas in the service area can have a second precision (e.g., a precision of seven or six characters), and the first precision can have a higher precision than the second precision.

In some embodiments, to determine the income level of the passenger, the computer system can identify the first area of the plurality of areas in the service area, the geohash of the first area being the geohash of the residence address of the passenger. The computer system can obtain or determine the median property price of the first area of the plurality of areas in the service area. The computer system can obtain the median property price of the service area. The computer system can determine an income score of the passenger comprising a ratio of the median property price of the first area and the median property price of the service area. The income score of the passenger can indicate the income level of the passenger. The median property price of the first area can be calculated on a per passenger basis.

In some embodiments, to determine the income level of the passenger, the computer system can obtain or determine a median property price of each of the plurality of areas in the service area that is available. The computer system can obtain the median property price of the service area. The computer system can determine a ratio of the median property price of each of the plurality of areas in the service area and the median property price of the service area. The computer system can identify the first area of the plurality of areas in the service area. The computer system can determine an income score of the passenger comprising the ratio of the median property price of the first area and the median property price of the service area. The geohash of the residence address of the passenger can comprise the geohash of the first area. The income score of the passenger can indicate the income level of the passenger. The median property price of the first area can be calculated on a per area basis.

The income score of the passenger, ranked relative to income scores of other passengers of the system, indicates the income level of the passenger. Alternatively or additionally, the income score of the passenger, ranked relative to ratios of (i) median property prices of areas of the plurality of areas in the service area other than the first service area and (ii) the median property price of the service areas, indicates the income level of the passenger.

In some embodiments, the computer system can determine the median property price of each of the plurality of areas on the service area that is available periodically. The computer system can determine rankings of passengers of the system based on income levels of the passengers periodically.

In some embodiments, to determine the income score of the passenger, the computer system can update the income score of the passenger from 0.5 to the ratio of the median property price of the first area and the median property price of the service area.

In some embodiments, to determine the income level of the passenger, the computer system can determine median property prices of areas of the plurality of areas in the service area. A median property price of a second area of the plurality of areas comprised in the first area can be unavailable. The geohash of the second area and the geohash of the residence property of the passenger can be identical and have a precision higher than the geohash of the first area. The computer system can obtain the median property price of the service area. The computer system can determine ratios of the median property prices of the areas of the plurality of areas in the service area and the median property price of the service area. The computer system can identify the geohash of the second area and the geohash of the residence address of the passenger are identical and the median property price of the second area is unavailable. The computer system can identify the first area of the plurality of areas in the service area as having the geohash of the first area comprised in the geohash of the residence address of the passenger. The computer system can determine an income score of the passenger comprising the ratio of the median property price of the first area and the median property price of the service area, wherein the income score of the passenger indicates the income level of the passenger.

With respect to the method 600, at block 616, the computer system can receive a trip order (or a trip request) from the passenger. With respect to the method 600, at block 620, the computer system can optionally determine a decision for the trip order based on the income level of the passenger. The computer system can optionally determine the decision for the trip order based on the risk for the driver for the trip order. The risk for the driver can be determined based on the income level of the passenger. The risk for the driver can be determined based on the passenger's prior behavior, such as the number of recent trip orders, the number of recent canceled trip orders, and driver identities and car models of the recent trip orders and canceled trip orders. The risk for the driver can be determined based on the pickup location, the drop off location, the pickup time, the estimated drop off time, the estimated trip duration of the trip order, and the estimated route for the trip order. The risk for the driver can be determined based on the review of the passenger by drivers who have provided transportation services for the passenger. The decision for the trip order can be an acceptance of the trip order and a decline of the trip order. The decision for the trip order can be a particular driver to assign to the trip order.

In some embodiments, the decision for the trip order can be a discounted price for the trip order and/or a number of subsequent trip orders (e.g., 2, 3, 5, 10, or more subsequent trip orders). For example, if the income level of the passenger is in the bottom 25th percentile to the bottom 10th percentile, the price of the trip order can be discounted by 10%. As another example, if the income level of the passenger is in the bottom 10th percentile, the price of the trip order can be discounted by 25%. In some embodiments, the decision for the trip order can be a price for the trip order and/or a number of subsequent trip orders. For example, the price for the trip ordered can be inversely proportionally to the income level of the passenger. As another example, the price for the trip ordered can be tiered and based on the income level of the passenger.

### Computer System

FIG. 7 is a block diagram that illustrates a computer system 700 upon which any of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor(s) 704. Main memory 706 also may be used for storing temporary variables or other intermediate information during execution of instructions to be executed by processor(s) 704. Such instructions, when stored in storage media accessible to processor(s) 704, render computer system 700 into a special-purpose machine that is customized to perform the operations specified in the instructions. Main memory 706 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 708. Execution of the sequences of instructions contained in main memory 706 causes processor(s) 704 to perform the process steps described herein. For example, the process/method shown in FIG. 6 and described in connection with this figure may be implemented by computer program instructions stored in main memory 706. When these instructions are executed by processor(s) 704, they may perform the steps as shown in FIG. 6 and described above. In alternative embodiments, hard-wired circuitry may be used in place of or in combination with software instructions.

The computer system 700 also includes a communication interface 710 coupled to bus 702. Communication interface 710 provides a two-way data communication coupling to one or more network links that are connected to one or more networks. As another example, communication interface 710 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may comprise instructions which may program or configure the computing system 102 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A system for ridesharing, the system comprising:
one or more processors; and
a memory storing instructions that, when executed by the one or more processors, cause the system to perform:
receiving a trip order from a passenger;
determining a residence address of the passenger;
determining a geohash of the residence address of the passenger; and
determining an income level of the passenger based on
(i) a median property price of a first area of a plurality of areas in a service area, wherein the geohash of the residence address of the passenger comprises a geohash of the first area of the plurality of areas in the service area, and
(ii) the median property price of the service area;
determine a risk for the trip order based on the income level of the passenger; and
determining a decision for the trip order based on the risk of the trip order.

2. The system of claim 1, wherein the decision for the trip order comprises an acceptance of the trip order and a decline of the trip order.

3. A system comprising:
one or more processors; and
a memory storing instructions that, when executed by the one or more processors, cause the system to perform:
determining a residence address of a passenger;
determining a geohash of the residence address of the passenger;
determining an income level of the passenger based on a ratio of
(i) a median property price of a first area of a plurality of areas in a service area, wherein the geohash of the residence address of the passenger comprises a geohash of the first area of the plurality of areas in the service area, and
(ii) the median property price of the service area;
receiving a new trip order from the passenger; and
determining a decision for the new trip order based on the income level of the passenger.

4. The system of claim 3, wherein none of the plurality of areas in the service area overlap with one another, and wherein different areas of the plurality of areas in the service area have different geohashes.

5. The system of claim 3, wherein determining the residence address of the passenger comprises determining the residence address of the passenger based on a location of the passenger during registration with the system, wherein the location of the passenger comprises a longitude and a latitude, and wherein the location of the passenger during registration with the system corresponds to a residence address in the service area.

6. The system of claim 3, wherein determining the residence address of the passenger comprises:
determining geohashes of a start location and a destination location of each of a plurality of recent trip orders of the passenger;
determining a number of the geohashes of the start locations and the destination locations having an identical geohash is at least an identical geohash threshold, wherein the identical geohash is a geohash of a residence address in the service area; and
determining the identical geohash as the geohash of the residence address of the passenger.

7. The system of claim 3, wherein determining the residence address of the passenger comprises:
determining geohashes of a start location and a destination location of each of a plurality of recent trip orders of the passenger;
determining a number of the geohashes of the start locations and the destination locations having an identical geohash is below an identical geohash threshold; and
determining a geohash of a start location or a destination location of a most recent trip order of the plurality of recent trip orders of the passenger as the geohash of the residence address of the passenger, wherein the start location or the destination location of the most recent trip order determined as the residence address of the passenger is a residence address in the service area.

8. The system of claim 3, wherein the geohash of the residence address of the passenger has a first precision, and wherein the geohash of the first area of the plurality of areas in the service area has the first precision.

9. The system of claim 3, wherein the geohash of the residence address of the passenger has a first precision, wherein the geohash of the first area of the plurality of areas in the service area has a second precision, and wherein the first precision has a higher precision than the second precision.

10. The system of claim 3, wherein determining the income level of the passenger comprises:
identifying the first area of the plurality of areas in the service area, the geohash of the first area being the geohash of the residence address of the passenger;
obtaining the median property price of the first area of the plurality of areas in the service area;
obtaining the median property price of the service area; and
determining an income score of the passenger comprising a ratio of the median property price of the first area and the median property price of the service area, wherein the income score of the passenger indicates the income level of the passenger.

11. The system of claim 3, wherein determining the income level of the passenger comprises:
obtaining a median property price of each of the plurality of areas in the service area that is available;
obtaining the median property price of the service area;
determining a ratio of the median property price of each of the plurality of areas in the service area and the median property price of the service area;
identifying the first area of the plurality of areas in the service area, wherein the geohash of the residence address of the passenger comprises the geohash of the first area; and
determining an income score of the passenger comprising the ratio of the median property price of the first area and the median property price of the service area, wherein the income score of the passenger indicates the income level of the passenger.

12. The system of claim 11, wherein the income score of the passenger, ranked relative to income scores of other passengers of the system, indicates the income level of the passenger.

13. The system of claim 11, wherein the income score of the passenger, ranked relative to ratios of (i) median property prices of areas of the plurality of areas in the service area other than the first service area and (ii) the median property price of the service areas, indicates the income level of the passenger.

14. The system of claim 11, wherein the instructions, when executed by the one or more processors, cause the system to perform:
determining the median property price of each of the plurality of areas on the service area that is available periodically; and/or
determining rankings of passengers of the system based on income levels of the passengers periodically.

15. The system of claim 11, wherein determining the income score of the passenger comprises updating the income score of the passenger from 0.5 to the ratio of the median property price of the first area and the median property price of the service area.

16. The system of claim 3, wherein determining the income level of the passenger comprises:
determining median property prices of areas of the plurality of areas in the service area, wherein a median property price of a second area of the plurality of areas comprised in the first area is unavailable, wherein the geohash of the second area and the geohash of the residence property of the passenger are identical and have a precision higher than the geohash of the first area;
obtaining the median property price of the service area;
determining ratios of the median property prices of the areas of the plurality of areas in the service area and the median property price of the service area;
identifying the geohash of the second area and the geohash of the residence address of the passenger are identical and the median property price of the second area is unavailable;
identifying the first area of the plurality of areas in the service area as having the geohash of the first area comprised in the geohash of the residence address of the passenger; and
determining an income score of the passenger comprising the ratio of the median property price of the first area and the median property price of the service area, wherein the income score of the passenger indicates the income level of the passenger.

17. The system of claim 3, wherein the decision for the trip order comprises an acceptance of the trip order and a decline of the trip order.

18. A method comprising:
determining a residence address of a passenger;
determining a geohash of the residence address of the passenger;
determining an income level of the passenger based on
(i) a median property price of a first area of a plurality of areas in a service area, wherein the geohash of the residence address of the passenger comprises a geohash of the first area of the plurality of areas in the service area, and
(ii) the median property price of the service area;
receiving a new trip order from the passenger; and
determining a decision for the new trip order based on the income level of the passenger.

19. The method of claim 18, wherein none of the plurality of areas in the service area overlap with one another, and wherein different areas of the plurality of areas in the service area have different geohashes.

20. The method of claim 18, wherein determining the residence address of the passenger comprises determining the residence address of the passenger based on a location of the passenger during registration with a ridesharing service or platform, wherein the location of the passenger comprises a longitude and a latitude, and wherein the location of the passenger during registration corresponds to a residence address in the service area.
